(19) United States
(12) Patent Application Publication
(10) Pub. No.: US 2001/0017681 A1
(43) Pub. Date: Aug. 30, 2001

(54) LIQUID CRYSTAL SHUTTER AND A LIGHT SHIELDING DEVICE INCLUDING SUCH A SHUTTER

(76) Inventors: AKE HORNELL, FALUN (SE); STEPHEN PALMER, BORLANGE (SE)

Correspondence Address: YOUNG & THOMPSON, 745 SOUTH 23RD STREET 2ND FLOOR, ARLINGTON, VA, 22202

(21) Appl. No.: 09/051,930

(22) PCT Filed: Oct. 25, 1996
(86) PCT No.: PCT/SE96/01373

§ 371 Date: None

(30) Foreign Application Priority Data
Oct. 26, 1995 (SE) 9503784-2

(51) Int. Cl. G02F 1/1335

(52) U.S. Cl. 349/117; 349/119; 349/14; 349/121

(57) ABSTRACT

A liquid crystal shutter construction, suitable for glass shields and automatically darkening welding glass filters, which shutter construction is switchable between a first state with high transmission of light and a second state with low transmission of light, and vice versa, in response to an electric control signal, the shutter construction having a nematic type liquid crystal cell disposed between transparent plates having electrodes for providing an electric field in response to the control signal, said plates having mutually facing surfaces, each of which is provided with alignment means for defining a respective molecule alignment direction for molecules in the proximity of said alignment means in the absence of said electric field, said liquid crystal cell being mounted between polarisers, wherein a retardation film is disposed between the polarisers in order to reduce remaining retardation in the liquid crystal cell when in an electrically activated state, said retardation film being arranged such that the fast axis of the retardation film differs from the fast axis of the inherent retardation of said cell.

The present invention relates to liquid crystal shutters and electro-optical eye-protection devices with variable transmission density, and then more specifically to constructions according to the preamble of the following claim 1.

### BACKGROUND

Liquid crystal shutters are useful in various applications concerning the transmittance of light through an aperture, in which it should be possible to switch the shutter between a transparent or light low light-absorbing state and a dark high light-absorbing stale. By combining polarisation filters and layers or cells of liquid crystal molecules that are alignable by means of an electric influence, the transmittance of a liquid crystal shutter construction is made variable in response to a change in the electric influence.

A state of the art liquid crystal cell in this context consists of a liquid mixture of elongated molecules sandwiched between two glass plates. The liquid mixture facing surfaces of the glass plates are grooved, for example by means of rubbing, in a uniform direction and the liquid crystal molecules close to such a surface tend to align parallel with the grooves or rubbing. By twisting the glass plates so that the groove directions are not-parallel, a helical structure of liquid crystal molecules is formed between the glass plates. For example, the standard 90° twisted nematic (TN) cell is formed with a twist angle between the molecule alignment directions of the glass plates of 90°. The molecules of a liquid crystal have an inherent dielectric anisotropy and can therefore be predominantly aligned upon application of an electric field with a voltage higher than a cell specific threshold value. The helical structure in the cell is then dissolved and the crystal molecules are instead oriented according to the electrical field. When placed between polarisers, the optical density of such a cell assembly can be controlled by varying the applied electrical field above the threshold voltage. With such a liquid crystal cell being placed between crossed polarisers, the cell construction has a high transmission, i.e. a low transmission density, in the absence of any stimulating voltage and is said to be in a normally white mode. In contrast to this, positioning of the cell between parallel polarisers results in a cell construction having a low transmittance, i.e. a high optical density, in the absence of a stimulating voltage, and is said to be in a normally black mode.

A typical cell construction consists of a twisted nematic (TN) type liquid crystal cell inserted between two mutually crossed polarisation filters, where the defining walls are treated with a plastic layer which has been brushed or rubbed in specific directions, the so-called alignment directions, so that the structure in the liquid crystal defining surfaces will force the nematic molecules to each take specific angular positions and so that the molecules will be twisted mutually through 90° between said defining surfaces. Other surface treatment methods which have corresponding effects are also known to the art. In an electrically non-activated state, the polarisation plane will be rotated through 90° as light passes through the filter, so as to compensate for the effect of the crossed polarisers and the cell becomes transparent. This rotation of the nematic molecules can be stopped to a greater or lesser extent, by applying an electric field and therewith obtain a filter effect that can also be controlled. However, a cell of this kind has a relatively strong asymmetry in its dark, electrically activated state, with varying absorption of light that is incident at angles other than a right angle, this asymmetry being further amplified by the fact that the nematic molecules nearest the surface, bound by the surface effect, still give rise to a residual optical activity. Thus, when the angles of incident light increase in relation to a perpendicular axis of the shutter surface, the filter in the two bisectrix directions between the alignment directions will be more transparent and relatively constant in relation to the directions of the crossed polarisers along the direction of one bisectrix while darkening along the direction of the other bisectrix.

In particular, when the above described kind of state of the art shutter is applied as a light filter in for example an eye-protection device, such as an automatically darkening welding glass shield in which the welding glass is activated and darkens in response to detected welding light, it is for safety reasons important to ensure that the fastest response time possible from the light state to the dark state is achieved. Basically, there are two switching times involved in the operation of a liquid crystal cell. The first involves switching the cell from the inactivated state to an activated state upon application of a driving voltage and it takes typically less than a millisecond for the crystal to react. The second switching time occurs in connection with the reverse process where crystal relaxation takes place upon removal of the driving voltage and takes around twenty times longer. Therefore, for shutters requiring very fast switching times from the light state to the dark state it is usual to employ liquid crystal cell constructions in the normally white mode. However, the optical angular properties of state of the art liquid crystal shutters that operate in a normally white mode have a transmittance that is highly dependent on the angle of incident light. An improvement in this respect has been provided in the copending but not yet published patent applications SE-9401423-0 and corresponding PCT/SE95/00455, where twist angles smaller than 90° and down to 0° between the molecule alignment directions of the glass plates have been described. More specifically, the angular variation in transmittance, is according to these applications reduced to a minimum by lowering the product of the optical anisotropy Δn and thickness d of the liquid crystal cell, i.e. the Δn*d parameter, and by reducing the liquid crystal molecular twist angle to below that of 90°.

Due to the optical anisotropy, light transmitted through a material or a material composition has different velocities in different directions. In this context, a fast axis is the axis along which light travels with the highest velocity through the material in question, and in a similar manner a slow axis is the axis along which light travels with the lowest velocity. A retardation value for light velocity in a specific material is defined by the difference between the refractive index Δn(f a.) for the fast axis and the refractive index Δn(s.a.) for the slow axis.

A minimum value of the Δn*d parameter results in a retardation of polarised light when in the inactivated phase and with a sufficiently high retardation value, the transmittance of the lightest state is maintained at a high level. This is particularly important in glass shield applications, such as automatically darkening welding glass shields, where the user of the glass shield requires a clear field of view prior to the commencement of an operation. This sets a lower limit to the value of the Δn*d parameter that can be obtained in practice.

Liquid crystal cell shutter constructions with low twist angles suffer from the drawback that there is an associated loss of cell contrast due to the remnant retardation left in the cell when driven at voltages of less than 10 volts. This drawback is accentuated as twist angles down towards 0° are reached, thus setting a practical lower limit to the value of the twist angle in the cell due to unacceptably low contrast. In the documents SE 9401423-0 and corresponding PCT/SE95/00455, it has been shown that there is a coupling between the Δn*d parameter and the twist angle in the cell and there is also a graph demonstrating the optimum Δn*d value for a given twist angle. A natural consequence of twist angle reduction is that the Δn*d parameter must also be lowered in order to induce the desired rotation of polarised light when in the inactivated phase.

In SID 95 Digest, P49: A High-Contrast Wide-Viewing-Angle Low-Twisted-Nematic LCD Mode by Hirakata et al, it has been suggested that it is possible to compensate for the remnant retardation present in a liquid crystal cell when in the activated phase by means of low value retardation films. With retardation film values lying in the 20-50 nm regions an increased cell contrast from a low twist cell back up to the level obtained with a standard 90° twist automatic cell is achieved. This document is oriented towards liquid crystal displays where it is desirable to have a high contrast ratio with a small applied voltage, and hence retardation values of 23 nm for a 70° twisting cell appear most appropriate.

The problem to be solved by the present invention, and thus an object of it, is to achieve an electrically controllable liquid crystal shutter with an improved contrast and a reduced angular transmission dependence in an electrically activated state.

A further object is to achieve a shutter of the mentioned kind with a highly symmetric shade geometry in its dark state and with a broad contrast range in the activated dark state.

Further objects of the present invention are to provide a glass shielding device and a welding glass construction with improved contrast and reduced angular transmission dependency.

### SUMMARY

According to the invention, the problem is solved and the objects achieved by providing a voltage controllable liquid crystal cell, placed between mutually perpendicular polarisers and having an angular displacement between the molecular alignment directions of the cell delimiting plates in the range from 0° to 85°, with a compensating retardation film.

Thus, in accordance with one aspect of the invention, a normally white mode liquid crystal cell having an optimum symmetric shade geometry with parallel molecular alignment directions, i.e. 0° twist angle, is provided with a retardation film, in order to reduce remaining retardation in the cell when in an electrically activated state.

For applications such as automatically darkening welding filters, it is desirable to have a grey scale capability where a maximum level of darkness is reached with voltages approaching 10 volts. In such embodiments of the invention, retardation values lying close to 10 nm for a 70° cell are required, and similarly a 23 nm film is more closely matched to that of the 40° twisting cell. In order to obtain maximum compensation for the remnant retardation present in a liquid crystal cell in the activated phase, the retardation film should be oriented such that the fast axis lies perpendicular to the bisector of the angle between the two molecular alignment directions at the surfaces of the cell delimiting plates. With this arrangement, not only is the compensation effect maximised, but in addition, the optical angular properties of the liquid crystal cell in the activated phase become significantly more symmetric around an axis perpendicular to the surface of the inventive liquid crystal cell construction in comparison with that of state of the art liquid crystal cells.

Retardation films with values of between 5 nm-50 nm have shown to be most appropriate in order to compensate for said remnant retardation. Although the optical angular properties of liquid crystal cells can be improved via reduction of the molecular twist angle in the cell, the practical twist angle interval is restricted from 50° to 85° due to the loss of cell contrast. However, with the retardation film compensation in accordance with the invention, twist angles ranging from 0° to 85° can be used without there being any cell contrast restrictions. The least twist angle possible, i.e. 0° or parallel alignment, represents the liquid crystal cell having the optimal optical angular properties when in the activated phase. In order to maintain a light transmittance at a high level, it is necessary to arrange the crossed polarisers such that their angular bisector is parallel with the bisector of the two molecular alignment directions at the surfaces of the cell sides.

According to another aspect of the invention, the use of a compensating retardation film in a liquid crystal shutter construction not only increases the cell contrast, it also reduces the voltage required to reach a specific level of optical density or darkness in the cell. This results in a net electrical power saving since the power consumption of a cell is proportional to the square of the driving voltage.

The compensating layer can either be in the form of a single, uniaxially stretched retardation film with a value between 5 nm and 50 nm, or as two or more retardation films that are aligned such that the net overall retardation generated by the retardation films lies within said retardation interval.

The invention will now be described in more detail with reference to exemplifying embodiments thereof and also with reference to the accompanying drawings, in which:

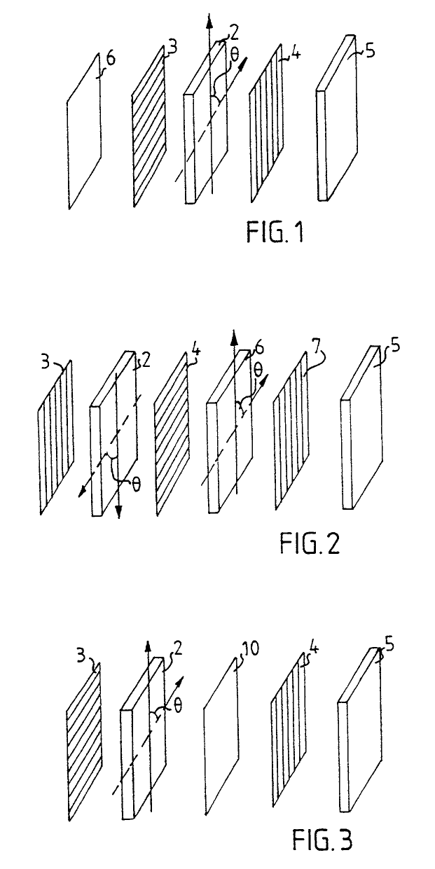

FIG. 1 shows an exploded view of a liquid crystal cell disposed between crossed polarisers;

FIG. 2 shows a liquid crystal cell construction comprising two liquid crystal cells;

FIG. 3 shows an embodiment of a liquid crystal cell combination in accordance with the invention;

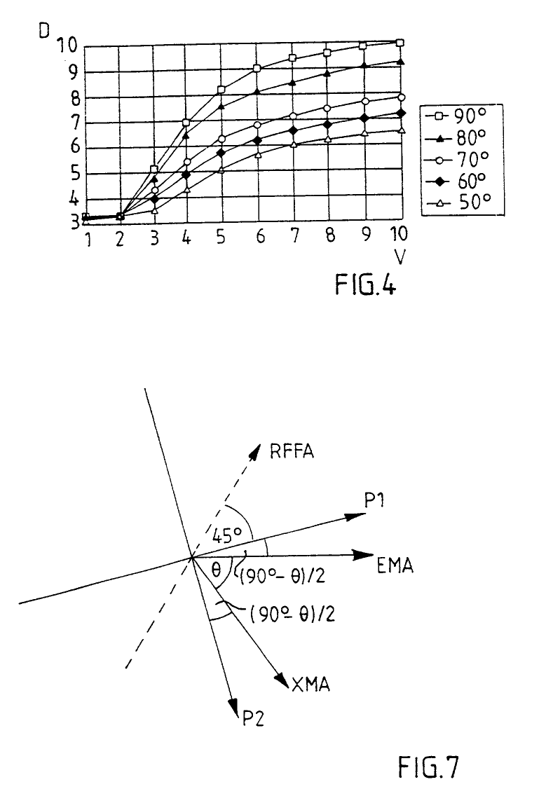

FIG. 4 shows the electro-optical properties of low twist cells with the optical density or shade number D of cell combinations with different twist angles plotted in relation to applied voltage;

FIG. 5 shows the quantity of retardation present in a liquid crystal cell as a function of an applied driving voltage for cells with different twist angles;

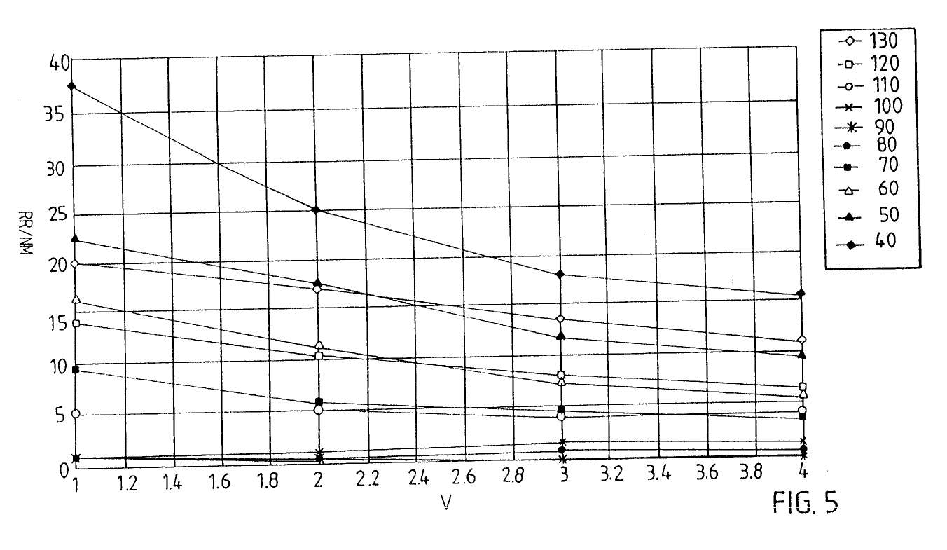

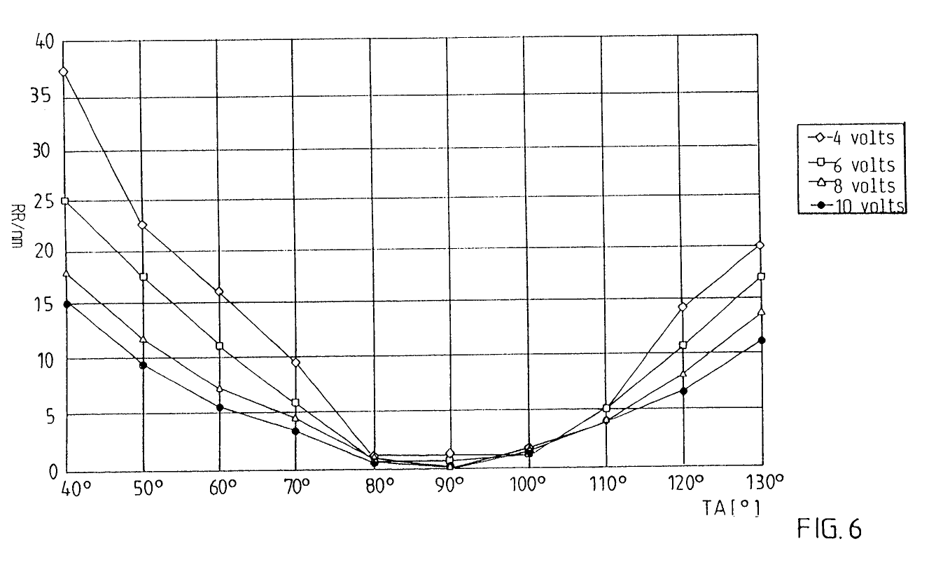

FIG. 6 again shows the quantity of remnant retardation in a liquid crystal cell as a function of the twist-angle for a number of different specific driving voltages;

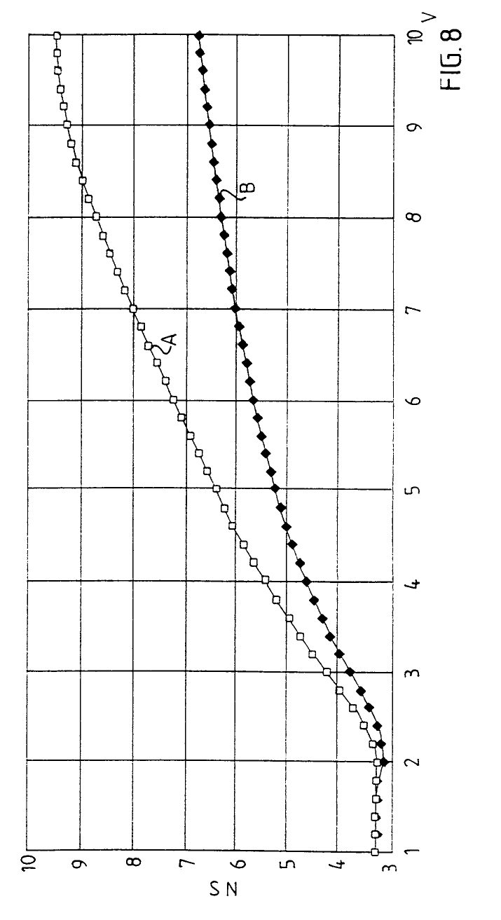

FIG. 7 shows a preferred orientation of polarisers and compensating retardation film alignment relative to the molecular alignment directors in a two-cell combination; and

FIG. 8 shows the transmission characteristics with shade number as a function of applied voltage for a low-twist liquid crystal two-cell combination with and without a compensating retardation film.

### DESCRIPTION OF EMBODIMENTS

FIG. 1 shows the various components of an embodiment of the inventive shutter construction, an optically rotating liquid crystal cell 2 is placed between a first polarisation filter 3 and a second polarisation filter 4, being arranged to be mutually extinguishing. An interference filter 6 and a band pass filter 5 may optionally be disposed outside either of the polarisers, and these filters may also be integrated in one unit. When such a shutter construction applied for example to a welding filter is taken into use, control circuits are activated and the optical density can in a per se known way be controlled by varying an applied cell driving voltage. A sensor (not shown) can detect whether or not welding light enters the shutter. If welding light is detected, the control circuit (not shown) causes a control voltage to be applied to the cell thus causing an increasing optical density in the cell construction.

FIG. 2 shows a similar cell construction, though with the first cell 2 placed between mutually extinguishing first polariser 3 and second polariser 4, and a second cell 6 placed between one of the first and second polarisers 3, 4 and a third polariser 7. The third polariser 7 and the closest first or second polariser 3, 4 are also arranged to be mutually extinguishing. In a manner similar to the embodiment of FIG. 1 there is also an interference filter and/or a band pass filter 5 which may be included in embodiments of the invention. In FIG. 1 as well as in FIG. 2 the twisting angles θ between the molecular alignment directions of a cell 2, 6 are indicated by means of crossed arrows.

As has been mentioned above, there is a remnant retardation present in a liquid crystal cell when in the activated state, giving rise to a reduced contrast although the angular dependence is optimised. The remnant retardation effects can be compensated for by means of a low value retardation film applied between the polarisation filters of a liquid crystal shutter construction.

FIG. 3 shows in principle such a shutter construction comprising one liquid crystal cell 2 placed between a first and a second mutually extinguishing polarisers 3 and 4, provided with a retardation film 10 disposed between said polarisers 3 and 4. In such a two-cell combination, the crossed polarisers should for the best shade symmetry be arranged such that their angular bisector is parallel with the angular bisector of the two molecular alignment directors at the surfaces of the cell delimiting plates. In this embodiments the lowest twist angle is 0°, which also gives the optimal optical angular properties, i.e. shade symmetry, when in the activated phase.

Furthermore, it is possible to arrange the retardation film within the liquid crystal cell 2 in connection with or between the cell delimiting plates. A liquid crystal cell with a retardation film may be included in any liquid crystal cell combination, such as the 1-cell combination of FIG. 1 or the 2-cell combination of FIG. 2.

A glare shielding device according to the invention includes a sensor for providing a sensor signal in response to the intensity of a detected light. The sensor signal is provided to a controller including a signal generator. The signal generator is set up to generate a control signal in response to the sensor signal.

A liquid crystal construction according to the invention includes a liquid crystal cell having two surfaces provided with electrodes for providing an electric field between these surfaces. The electric field is created by applying the control signal to the electrodes. When the control signal is applied to the electrodes, a certain control signal voltage will create a corresponding electric field in the liquid crystal cell between the electrodes.

FIG. 4 shows the electro-optical properties of 4 mm low twist cells with the optical density or shade number D of cell combinations with different twist angles plotted in relation to applied voltage. In is clearly seen in FIG. 4 that the contrast for a given voltage decreases with lower twist angles.

In order to increase the contrast in a low-twist two-cell combination, such as described in more detail in the documents SE 9401423-0 and corresponding PCT/SE95/00455, which has a what is believed to be optimal Δn*d value of about 0.275, it is provided with a compensating retardation film with a retardation value in the range of 25-30 nm. The retardation film should then preferably be oriented such that the fast axis is perpendicular to the angular bisector of the two molecular alignment directors of the cell-polariser combination, within which the retardation film is arranged.

FIG. 5 shows the quantity of remnant retardation (RR/nm) present in a liquid crystal cell as a function of an applied driving voltage V, and with retardation characteristics for different twist angles ranging from 40° to 130°. For the standard 90° twisted-nematic cell, the retardation effects due to the two layers of molecules in the proximity of the alignment surfaces cancel each other out, and hence there is little retardation left in the cell. This results in a high cell contrast being obtained in the activated phase in such a cell. However, as the twist-angle in the cell is varied over twist-angles different from 90°, the cancellation effect is reduced and the quantity of retardation left is increased and thus degrading cell contrast. In other words, the lower the twist-angle, the larger is the amount of remnant retardation in the cell. FIG. 6 again shows the quantity of remnant retardation (RR/nm) in a liquid crystal cell, but now as a function of the twist-angle TA for a number of different specific driving voltages.

FIG. 7 shows a preferred orientation of polarisers P1, P2 and compensating retardation film alignment relative to the molecular alignment directors in a two-cell combination with an entrance molecular alignment director EMA and an exit molecular alignment director XMA. In order to maximise the transmittance in the inactivated phase, the crossed polarisers are preferably aligned so that the angular bisector is parallel to the angular bisector of the two alignment director vectors on each side of the cell. Furthermore, in order to maximise the compensating effect when in the activated phase, the fast axis of the retardation film RFFA should be oriented perpendicular to the angular bisector of the alignment director vectors.

FIG. 8 shows the transmission characteristics with optical density or shade number SN as a function of applied voltage V for a 4 μm 40° liquid crystal two-cell combination with (Plot A) and without (Plot B) a 44 nm compensating retardation film, and the difference in shade contrast is clearly shown.

Different kinds of cell combinations for liquid crystal shutter constructions may thus be provided with a compensating retardation layer selected for an optimal compensation of inherent remnant cell retardation in accordance with the inventive concept.

1. A liquid crystal shutter construction, suitable for glass shields and automatically darkening welding glass filters, the shutter construction being switchable between a first state with high transmission of light and a second state with low transmission of light, and vice versa, in response to an electric control signal, the shutter construction having a nematic type liquid crystal cell disposed between transparent plates having electrodes for providing an electric field in response to the control signal, said plates having mutually facing surfaces, each of which is provided with alignment means for defining a respective molecule alignment direction for molecules in the proximity of said alignment means in the absence of said electric field, said liquid crystal cell being mounted between poLarisers, characterized in a retardation means disposed between the polarisers and being devised to compensate for remaining retardation of the liquid crystal cell when in an electrically activated state, said retardation means being arranged such that a fast axis of the retardation means differs from a fast axis of the inherent retardation of the liquid crystal cell.

2. A shutter construction according to claim 1, characterized in that the angle between the fast axis of the retardation means and the fast axis of the inherent retardation of the liquid crystal cell is in the range between 45° and 90°.

3. A shutter construction according to claim 1 or 2, characterized in that the fast axis of the retardation means is essentially perpendicular to the fast axis of the inherent retardation of the liquid crystal cell.

4. A shutter construction according to any of the preceding claims 1-3, characterized in that the fast axis of the retardation means differs from the direction of the bisectrix of the angle between the molecular alignment directions.

5. A shutter construction according to any of the preceding claims 1-4, characterized in that the fast axis of the retardation means is disposed perpendicular to the bisectrix of the angle between the molecular alignment directions.

6. A shutter construction according to any of the preceding claims, characterized in that the angular displacement between the molecular alignment directions is in the range between 0° to 85°.

7. A shutter construction according to any of the preceding claims, characterized in that the alignment directions are parallel, i.e. the angular displacement between the alignment directions is 0°.

8. A shutter construction according to any of the preceding claims, characterized in that it further comprises a second cell and a second polarisation filter.

9. A shutter construction according to any of the preceding claims, characterized in a band-pass filter with a transmission characteristics having a transmittance maximum in the central part of the visible wavelength range, essentially between 500 and 600 nm, and in that the liquid crystal cell is selected such that it has transmission characteristics essentially complementary to the transmission characteristics of the band-pass filter.

10. A shutter construction according to any of the preceding claims, characterized in that the retardation means is a retardation film constituting a compensating layer.

11. A light shielding device including a shutter construction according to any one of the preceding claims.

12. A light shielding device according to claim 11, characterized in that it includes a sensor means for providing a sensor signal in response to the intensity of light; and a signal generator for generating said electric control signal in response to said sensor signal.
